(19) United States
(12) Patent Application Publication
(10) Pub. No.: US 2015/0366178 A1
(43) Pub. Date: Dec. 24, 2015

(54) FISHING LURE WITH LIGHTS

(71) Applicant: Jerry R. Bechhold, Foresthill, CA (US)

(72) Inventor: Jerry R. Bechhold, Foresthill, CA (US)

(21) Appl. No.: 14/746,803

(22) Filed: Jun. 22, 2015

Related U.S. Application Data
(60) Provisional application No. 62/015,239, filed on Jun. 20, 2014.

(51) Int. Cl. A01K 85/01

(52) U.S. Cl. CPC A01K 85/01

(57) ABSTRACT

An illuminated fish attractor with water-activated swiveling lights that illuminate the lure and create distinct movement patterns that enhance lure attractiveness to predatory fish, thereby inducing reaction and feeding strikes.

### CROSS REFERENCES TO RELATED APPLICATIONS

The present application claims priority to, and the benefit of the filing date of U.S. Provisional Patent Application Ser. No. [TBD], filed Jun. 20, 2014, incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates generally to fishing lures, and more particularly to a lure having at least one, and preferably several LED lights disposed on or within the lure body.

2. Background Discussion

The purpose of the inventive illuminated flasher or dodger is to attract all species of predatory fish using lights of different colors. Fish are attracted to light, sound, and smell. To the present no known flasher, dodger, or similar fish attractant device, has included lights functioning as a source of incident, rather than reflected light. The proposed system has lights disposed on and/or incorporated into the lure body, thus improving on the known devices with reflective elements only.

The field of fishing lures is crowded with countless creative solutions to the numerous problems anglers have encountered in the field. The general philosophy underlying lure design is to provide a device that closely mimics the most attractive prey for the sought-after predatory species of fish. To that end, lures have been designed to mimic both the movements and the appearance of bait fish. In some instances, successful lures, while not imitating food in the field, have mysteriously attracted fish for reasons that cannot be ascertained and evidently have nothing to do with technology imitating nature. In fact, successful lures need not closely imitate aquatic or insect life. It is known that shiny metallic objects with certain spinning movements will elicit a strike response in fish. One such lure is the well-known spinning lure, of which there are countless iterations. Illustrative of the spinning lures is U.S. Pat. No. 6,108,961 to Milawski, et al, issued Aug. 29, 2000. This patent discloses a twisted, spinning fishing lure and counterweight that comprises a proximal end, a distal end, a counterbalance arm, and a rotatable helical body element having a lumen passing entirely through the body and a wire extending through the lumen. The wire includes a proximal portion having a eyelet for attaching to a fishing line and a counterbalance arm extending distally from the eyelet. Bearings reduce rotational forces from being transmitted from the rotatable helical body element to the wire extending through the body lumen. Any rotation forces transmitted to the wire are purportedly opposed by the counterbalance arm. The design provides for a pure spinning motion of the helical spinner body when dragged underwater.

U.S. Pat. No. 6,112,450 to Studanski, issued Sep. 5, 2000, discloses a zigzag aquatic device tethered by a single line that provides an accentuated zigzag or oscillating movement when the device has a relative speed with respect to water.

U.S. Pat. No. 6,115,957 to Bocach, issued Sep. 12, 2000, teaches a fishing lure including a body member having a wing member coupled to the body member with one of the ends of the wing member outwardly extending from one of the sides of the body member and the other end of the wing member outwardly extending from the other side of the body member. The second end of an elongate front flexible member is coupled to the front of the body member while the second end of an elongate rear member is detachably attached to the back of the body member.

U.S. Pat. No. 6,243,982 to Halterman, Jr. Jun. 12, 2001, discloses a spinner for spinning lures formed to resemble a small bait fish which rotates in moving air or water as a result of action against the broad surfaces of the tail fin plates and the internal broad surfaces of the spinner bodies.

Numerous fishing tackle manufacturers currently offer pull bait and jerk bait Mepps-type, blade bait lures that employ rotating blades. Occasionally spinners are equipped with an in-line blade or propeller-type spinning blade that eliminates the need to use a clevis to allow free spinning of the blade. In either case, the blades are mounted on a bead, bearing, or central shaft that spins freely on leader immediately in front of the hook. The hook is frequently disguised within some type of tail at the end of the lure body.

An improvement on all of the foregoing prior art devices was taught in U.S. Pat. No. 6,493,984 to Bechhold (the present inventor), which patent is incorporated in its entirety by reference herein. The present invention represents yet further inventive improvements, including improvements to the flasher disclosed in the '984 patent.

### BRIEF SUMMARY OF THE INVENTION

As with the flasher of the '984 patent, the fishing lure and trolling flasher of the present invention has a geometry that produces a differential radius of rotation in the front and back ends during trolling at any speeds. The lure comprises a front end, a back end, a top side, a bottom side, and a beveled edge bordering the entire lure that tapers downwardly from the top to the bottom side and from the front to the back end. A front stabilizing fin is substantially parallel with the longest dimension (longitudinal axis) of the lure and has an eyelet for connection to the end of a fishing line having a spinner. A rear fin is set diagonally at an angle from the longitudinal axis. The rear fin includes at least one eyelet that may be fastened to a tail leader. The fin design induces an infundibular rotational motion and whipping effect of the lure even at slow trolling speeds. Water distortion induced by the lure motion produces sounds particularly attractive to predatory fish and triggers both reaction strikes or feeding strikes.

Positioning multiple rear end eyelets offers the fisherman distinct actions or variations on the lure motion to give the lure versatility for use when fishing for multiple species of fish.

The lure is preferably fabricated from a hard plastic or polymeric material, more preferably from a transparent or semi-transparent material. A holographic tape may be applied to one or more of the top and bottom surfaces or positioned between layers of a laminated lure body.

Most importantly, included in the inventive improvement are LED lights that create a nearly irresistible attractant to predatory fish.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of the fishing lure of the present invention;

FIG. 2 is a top plan view of the lure of FIG. 1;

FIG. 3 is a side elevation view of the lure of FIGS. 1 and 2; and

FIG. 4 is a front end view in elevation showing the pivotal motion of the lights when the lure is in use.

### DETAILED DESCRIPTION OF THE INVENTION

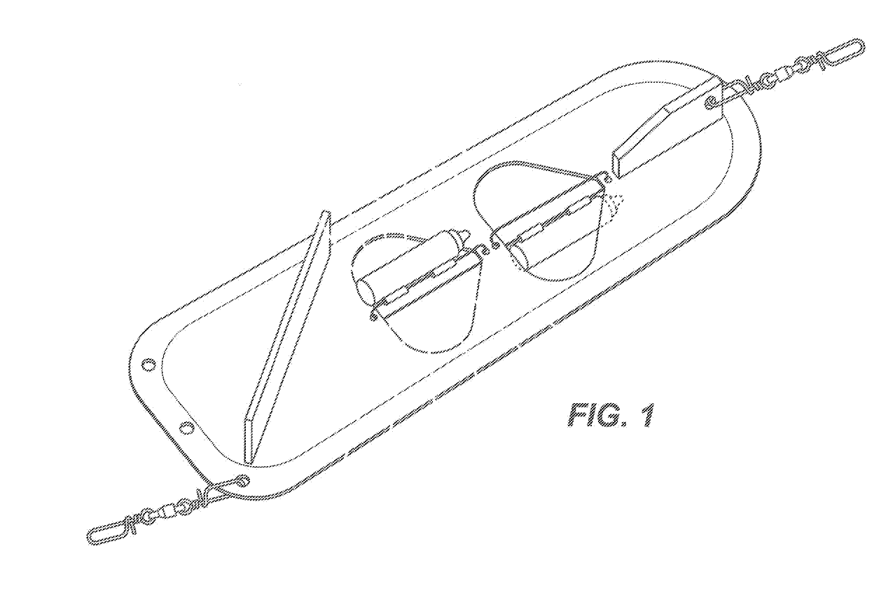

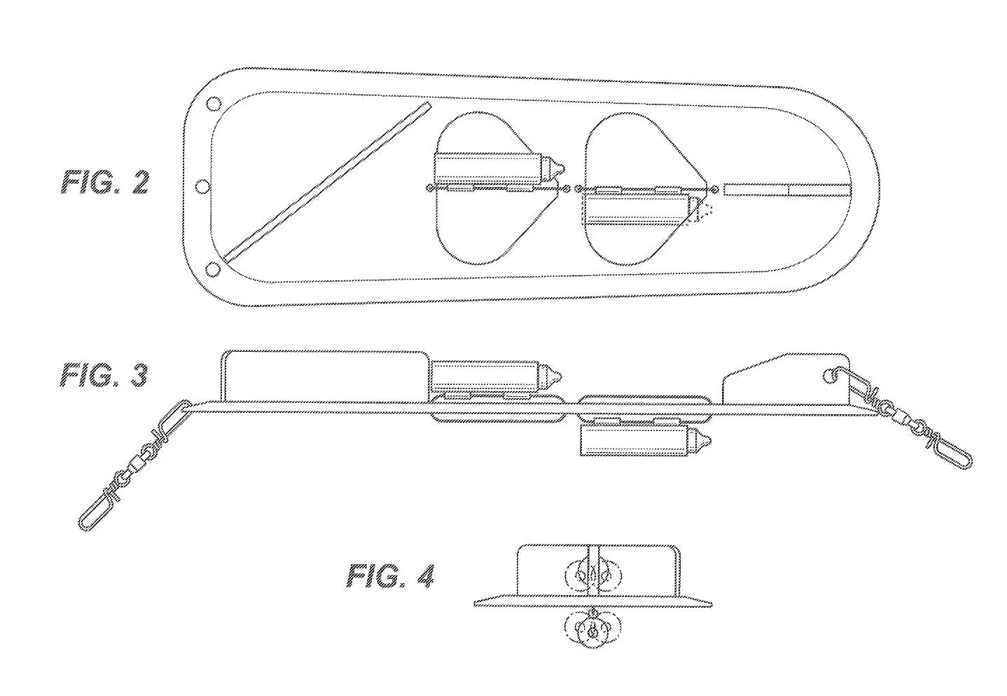

Referring to FIGS. 1 through 4, wherein like reference numerals refer to like components in the various views, there is illustrated therein a new and improved fishing lure and trolling flasher, the body of which is generally denominated 10. The body includes a geometry adapted to produce a differential range of rotation in the front and back ends during trolling, thereby creating an infundibular rotational pattern. The lure comprises a front or proximal end 12, a back, distal, or butt end 14, a substantially planar top side 16, a substantially planar bottom side 18, and a beveled edge 20 bordering the entire edge of the lure body and that tapers downwardly from the top to the bottom side and from the front to the back end. The lure further includes a front stabilizing fin 22, disposed substantially parallel to the longitudinal axis L of the lure body and at least one eyelet 24 for connection to the end of a fishing line having a spinner or swivel SW proximate the lure, and a rear fin 26 set diagonally at substantially an angle from the longitudinal axis of the lure illustrated, though variations are desirable for differing sizes as is necessary to produce the desired rotational motions, as described below. The rear fin further spans the distance from its foremost end 28 at the border of the beveled edge to its rearmost end 30 proximate a first of three rear end eyelets 32, 34, and 36, any of which may be fastened to a tail leader. Fin eyelets (not shown in the views) may be positioned in the rear fin to provide yet more alternatives for connection of the tail leader.

The fin configuration induces a rotational motion of the lure even at slow trolling speeds, and he tapered shape of the lure creates a kind of dynamic infundibular (funnel form, or conical) motion and whipping effect when the lure is used with a tail leader of less than 40 inches in length. This effect is most pronounced when the tail leader length is between 18 and 24 inches. Moreover, the water distortions induced by the lure motion produces sound effects that are particularly attractive to predatory fish.

The three rear end eyelets offer the user three distinct actions or variations on the lure motion to give the lure versatility for use when fishing for multiple species of fish. The outside eyelet 36 has the fastest whipping motion, and the inside eyelet 32 has the slowest. The middle eyelet, accordingly, is a suitable medium. In every case, however, the lure's motion is infundibular, or conical, wherein the front end 12 of the lure rotates in a circle having a radius substantially smaller than the radius of the circle described by the rotation of the back end 14. This provides a substantial “kick” on the bait even at slow trolling speeds.

As will be readily appreciated, the front end of the lure is connected to a fishing line while the rear end is connected to a tail leader. The twisting and spinning induced by the lure creates a potential for line twisting, tangling and breaking This is prevented through the use of a front bearing assembly or swivel 40 and a rear bearing assembly 42, each of which allow the lure to spin freely while keeping the line and the leader from any conflicting twisting.

The lure may be manufactured of any of a number of suitable materials, though a hard plastic or polymeric material is preferred. Even more preferably, the lure may be fabricated from a transparent or semi-transparent material. Further, a highly reflective holographic tape may be applied to one or more of the top and bottom surfaces, 16 and 18, of the lure or sandwiched between layers of a laminated lure body. This tape cooperates with the lights, described below, and is adapted for use in both fresh and salt water. Even alone it has been demonstrated to have a dramatic impact on the effectiveness of the lure. When the lure body is fabricated from transparent or semitransparent material, the beveled edge itself produces a prism-like effect from sunlight, but this effect is accentuated by the holographic tape. The sparkling effect and the arrays of colors that emanate from the lure simulate the effect of light reflecting off many species of fish.

Adding to the effect of holographic or other reflective tape—more accurately, significantly surpassing in effect—and further adding to the prism-like effect of the beveled edges, the inventive lure is provided with water-activated sources of incident light that produce nearly irresistible attractants to predatory fish as the light interacts with the lure body and that surrounding water.

Preferably, the lure includes at least one, and more preferably two, cutouts, e.g., first and second cutouts, 44, 46—each generally centered along the longitudinal centerline of the lure and having an elongate hoop or wire—first and second wire 48, 50, respectively—disposed within each cutout space and secured through holes, 52, 54 for the front cutout and 56, 58 for the rear cutout.

A lower light assembly 60 and an upper light assembly 62 are then secured on the wires so as to enable the lights to swivel about the wire. The light assemblies each include a cylindrical housing 64, 66, containing a power source, such as a lithium battery or a water-activated capacitor—to power a low power LED, preferably having a colored lens 68, 70. Integrally disposed on the housings are sleeves, 72, 74 dimensioned to allow free pivoting of the housing about the wire as the lure is pulled through water. The constraint on movement of the light assembly is the lure body itself, 10, which maintains the lights in their upper and lower positions, respectively. However, it will be appreciated that cutouts, wires, and lights may be sized to enable free rotation about a singular wire disposed within the cutout such that the lights may spin within the cutout and bob up and down between the upper and lower surfaces of the lure body. This may further enhance the attractive quality of the lure.

Thus, in another aspect, and in the most general terms, the present invention may be characterized as an illuminated trolling flasher, comprising an elongate lure body tapering outwardly from a proximal end to a distal end, a substantially planar top side, a substantially planar bottom side, and a beveled edge; a front stabilizing fin disposed substantially parallel to the longest dimension of the elongate flasher body; a rear fin disposed diagonally relative to the longest dimension of the elongate flasher body; means for connecting the proximal end of the flasher to a fishing line; means for connecting the distal end to a tail leader; reflective material for reflecting light from at least one of either the top or bottom sides; and sources of incident light, preferably comprising low powered water-activated LED strobe lights disposed in cylindrical light housings and pivotally secured within cutouts within the lure body so as to allow movement of the lights in relation to the lure body. While stroboscopic illumination has proven to be especially effective, constant illumination is also effective and preferred in some environments.

In an alternative embodiment, the LED lights may be attached in a fixed manner to one or the other surface of the lure. The water-activated lights include circuitry in which the circuit ground is completed when the lure is immersed in water containing even small concentrations of minerals or salts. Uninterrupted operation can continue for hours.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. An illuminated fishing lure, comprising:
a lure body; and
at least one source of incident light disposed on said lure body.

2. The fishing lure of claim 1, wherein said at least one source of incident light comprises a water-activated LED light.

3. The fishing lure of claim 2, including at least two water-activated LED lights.

4. The fishing lure of claim 2, wherein said lure body includes a cutout in which each of said water-activated LED lights are disposed.

5. The fishing lure of claim 4, wherein said LED lights include each include a light assembly having a housing containing a water-activated circuit.

6. The fishing lure of claim 5, wherein each of said cutouts includes a wire disposed between a front end and a rear end, and said LED lights are pivotally disposed on said wire.

7. The fishing lure of claim 6, wherein said LED lights pivot on said wire when said lure body is pulled through water.

8. The fishing lure of claim 7, wherein the motion of said LED lights is limited to an area either above said lure body or below said lure body.

9. The fishing lure of claim 1, wherein said at least one source of incident light is pivotally connected to structure on a longitudinal axis of said lure body.

10. The fishing lure of claim 9, wherein said at least one source of incident light is a water-activated LED light disposed in a light housing.

11. An illuminated fishing lure for use in trolling which produces an asymmetrical spinning motion having a differential range of rotation from one end of the lure to the other and moving incident light sources, said lure comprising:
a lure body having a front end, a back end, a top side, a bottom side, and a longitudinal axis, said lure body tapering outwardly from said front end to said rear end, and at least one eyelet at said rear end for connection to a tail leader;
a front stabilizing fin having at least one eyelet for connection to the end of a fishing line;
a diagonal rear fin having a front end and a rear end;
at least one source of movable incident light source disposed on said lure body;
characterized in that the fin configuration induces a rotational motion and the tapered shape of said lure body produces a dynamic asymmetrical conical motion from said front end to said back end while trolling, and said movable incident light source pivots about the longitudinal axis of said lure body.

12. The fishing lure of claim 11, wherein said lure body has a beveled edge that tapers downwardly from said top to said bottom side and from said front to said back end.

13. The fishing lure of claim 11, wherein said front fin is disposed substantially parallel to said longitudinal axis of said lure body.

14. The fishing lure of claim 11, wherein said lure body is fabricated from a transparent polymeric material.
